(19) United States
(12) Patent Application Publication
(10) Pub. No.: US 2009/0014174 A1
(43) Pub. Date: Jan. 15, 2009

(54) Use of coated slots for control of sand or other solids in wells completed for production of fluids

(75) Inventor: E. Douglas Hollies, Calgary (CA)

Correspondence Address: MACPHERSON KWOK CHEN & HEID LLP, 2033 GATEWAY PLACE, SUITE 400, SAN JOSE, CA, 95110, US

(73) Assignee: EnCana Corporation, Calgary (CA)

(21) Appl. No.: 12/005,815

(22) Filed: Dec. 28, 2007

Related U.S. Application Data
(60) Provisional application No. 60/877,769, filed on Dec. 29, 2006.

(51) Int. Cl. E21B 43/08; B05D 5/00

(52) U.S. Cl. 166/228; 427/256

(57) ABSTRACT

The present invention relates to an approach to reducing or eliminating the plugging of slots in a slotted liner while otherwise allowing the liner to function in its normal capacity as a solids exclusion device which permits the reservoir fluids to flow through relatively freely. The approach taught by the present invention involves coating the surface of the slot with a suitable material. The coating at least partially covers the irregularities that are formed on the slot surfaces as a consequence of the slot manufacturing process. The presence of the coating results in a markedly reduced slot plugging problem while still enabling the slot to perform its main function in excluding or inhibiting the inflow of larger particles and allowing the inflow of fluids.

### CROSS REFERENCE TO RELATED APPLICATIONS

This application claims the benefit of priority of U.S. Provisional Patent Application No. 60/877,769 filed Dec. 29, 2006, which is incorporated herein by reference in its entirety.

### FIELD OF THE INVENTION

The present invention relates generally to methods and apparatus for solids control in oil and gas production. More particularly, the present invention relates to methods and apparatus for solids control in tubulars having through the wall flow openings.

### BACKGROUND OF THE INVENTION

Petroleum reservoirs typically consist of a solid porous and permeable medium within whose pores or interstices reside petroleum fluids and water. The solid medium is sometimes a consolidated or cemented material such as a reef carbonate or a well cemented sandstone. In many other instances throughout the world, however, particularly where sand structures are involved, the solid medium is not well cemented, and possibly not cemented at all.

This latter type of poorly cemented or non-cemented solid framework reflects a depositional environment whose evolution pre-dated, by a long period of time, the influx of petroleum fluids into its pores. Thus, the range of resident petroleum fluids that are found in poorly cemented sands worldwide is very broad and can include natural gas, or light, medium or heavy gravity oils, or bitumen.

In those instances where cementation of the solid particles is weak or non-existent, the flow of resident reservoir fluids in the vicinity of a well, where flux rates tend to be larger, may cause some of the particles to dislodge and migrate along with the fluids.

Thus, for example, consider a well that possesses no special device or equipment to control the inflow of solids. Suppose too that the well is producing fluids from a reservoir whose solid constituents include or consist primarily of poorly cemented solid particles. As fluids move from the reservoir into the wellbore, the solid grains located within the reservoir, but close to the interface with the wellbore, may dislodge and may enter the wellbore along with the fluids. If the solids are present in sufficient quantity, and if they are sufficiently large and possess high hardness, they may be capable of damaging equipment in the well, such as a downhole pump, or even the static tubulars within the wellbore. If they are transported to the surface, they can damage surface pumps and can accumulate in surface equipment such as separators, treaters or tanks.

As already noted, the presence of high flux rates or velocities, such as those that occur in the vicinity of a well, contributes to this solids dislodgement phenomenon. In addition, the severity of this problem can be exacerbated when the petroleum fluid has a high viscosity. The higher viscosity can exert a stronger drag force on the uncemented solid particles with which it comes in contact in the vicinity of the wellbore, thereby causing them to dislodge.

In an effort to deal with the inflow of solid particles from the reservoir into the wellbore, the petroleum industry has adopted two fundamental approaches:

The first approach involves taking no special steps to control the inflow of solids into the wellbore. Under this approach, solids that dislodge are allowed to migrate into the wellbore, and specialized pumping equipment is used to bring the fluids and associated solids to the surface for subsequent separation and treatment. Over time, the continuing production of solids may result in the formation of a cavity in the vicinity of the wellbore. The diameter of that cavity will increase as more solids from that region are produced. Eventually, when the cavity diameter is sufficiently large, so that the fluid velocity out of the reservoir and into the cavity is sufficiently small, dislodgement of the solids may slow or even cease. However this benefit may exact a price. One major concern is that this cavity or void space behind the casing removes support and can allow the cemented pipe, which carries the overburden load, to buckle and fail. A second major concern with this type of approach is the resulting erosion of equipment during the solids production phase, and in particular the erosion of those types of equipment with moving parts such as downhole pumps. Thus, the production mechanism influences not only the quantity and type of solids influx into the wellbore, but can also cause or play a role in wellbore failures

The second approach involves installing a tubular device or assembly in the wellbore substantially opposite the reservoir. The device is manufactured to include a multiplicity of openings. The intent is that the size and distribution density of these openings are designed so that reservoir fluids will move through the openings and into the wellbore while mobile solids above a certain size will be prevented by the dimensions of the openings from transiting through them. This second approach is the more commonly used of the two alternatives and will be the focus of the remainder of this document.

Within the petroleum industry, four popular designs of a tubular device that will restrict solids entry have emerged—the wire wrap screen, the premium screen, the pre-packed screen and the slotted liner. These are described briefly below.

The wire wrap screen consists of a tubular base pipe with openings around which is wrapped a wire in helical fashion. A precision-placed space is left between each helical turn of the wire and its adjacent turns to allow fluid entry into the base pipe. Typically, the helically wound wire is welded to longitudinal ribs located at intervals along the outside of the pipe. The spacing between adjacent helical turns as well as the cross-sectional profile of the wire itself represent design parameters for the wire wrap screen.

The premium screen consists of a series of nested, wrapped wire mesh of variable size around a perforated base pipe. A recent variation of this design is an expandable screen which uses a special solid expandable casing metallurgy and tools to press the filter mesh against the formation face. The intent of this new feature is to eliminate sand dislodgement during fluid production.

One of the longstanding techniques within the industry for excluding solids influx has involved the use of gravel packs. Traditionally, these have consisted of sized sand that could be placed in the wellbore hydraulically so that the sand was deposited and formed a pack in the annular zone between the outside of the tubing and the inside of the casing, or the formation face itself. Variations of the gravel pack have included designs in which the sized sand pack is fixed to the outside of the tubing before the tubing is placed in the well. Thus, in the case of the pre-packed screen, instead of wrapping filter mesh around the slotted base pipe or wire-wrapped screen, a sized sand pack is held external to a base pipe by a mesh jacket. The intent is that the pre-packed screen will provide a low operational risk alternative to traditional gravel packs, whether in cased or open hole.

The slotted liner consists of a length of pipe into which slots have been cut. The slots are typically oriented longitudinally (but may be oriented transversely or oriented in a combination of longitudinally and transversely) and are characterized in terms of certain parameters. These parameters include slot width at the pipe's outer surface, width within the slot if different from the width at the outer surface, the manufacturing technique by which any such width variation was created, and the basic shape or cross-sectional profile of the slot.

The Present invention described herein concerns slotted liners.

Traditionally, the slotting process for a liner involves the application of small, thin, rapidly rotating circular saw blades to a length of tubular steel. Typically, slot widths are a fraction of a millimeter. Each blade cuts the slot to a specific length and, depending on the width of the blade, creates a slot of a prescribed width.

Typically, liners employ one of two basic slot geometries or configurations. One configuration involves a straight-cut slot in which the slot's cross-sectional width is uniform from outer to inner surface of the pipe. A second configuration, referred to as a keystone shape, involves a slot whose cross-sectional width at the interior of the pipe is greater than that at the exterior. The advantage of a slot which flares outward in this manner from the entry point to the exit point of the fluids and mobile solids is that a solid particle, once having passed through the entry of the slot, which is its narrowest point, is unlikely to become lodged within the slot where it can aid and abet plugging. A disadvantage of the keystone slot is that its manufacture requires two passes of the cutting blades, each at a different angle, to achieve the variable-width slot cross-section. In the course of making these oblique angle passes, the cutting blades tend to bend. Given the difficulties in maintaining manufacturing tolerances for these very narrow slot widths, even with a single pass of the blades, the tolerances associated with the keystone design are even more problematic. In a variation of the straight-cut slot which attempts to capture the advantage of the keystone configuration, the outer surface of the straight-cut slot is subjected to compression so that the slot width at or near the outer surface of the pipe is squeezed or reduced, whereas the original width is maintained in the downstream portion of the slot.

Industry techniques for choosing slot width attempt to consider factors such as the statistical distribution of solid particle sizes that are likely to migrate to the outer slot surface. Typically, a design criterion will be based on allowing a certain percentage of the particles to pass through the slot, with the remainder of the mobilized particles being restrained at the slot inlet. It is expected that, at the exterior surface of any one slot site, some of the solid particles will form a semi-stable structure over the slot. It is anticipated that this structure will be permeable and will function as a natural filter pack, thereby serving as an adjunct to further solids control. This formation of a semi-stable permeable structure is referred to as “bridging” and is a consideration in slot design.

The foregoing considerations notwithstanding, however, industry experience has repeatedly demonstrated that slot sizing based on these techniques cannot be relied upon consistently to minimize solids influx into the well tubulars while permitting relatively unimpeded flow of the fluids. Many sand reservoirs contain solid particles that are not only poorly cemented but are also highly variable in size, ranging from clean sand down to very fine clay particles. Frequently, in these circumstances, not only are the solids likely to be mobilized during production into a well, but the finer solids, such as clay particles, will often plug the slots. This plugging tendency of slotted liners is a major problem with the prior art.

### SUMMARY OF THE INVENTION

Our investigations have revealed that slot plugging occurs when the flour-like fines that are resident within the sand reservoir pore spaces move into the slot, adhere to the slot wall, and eventually back up into the sand bridge at the entry to the slot. This adherence to the slot wall is caused or facilitated by the uneven surface of the wall, whose irregular features we refer to as striations, resulting from, among other things, the blade cutting of the slots described earlier.

This result was further substantiated by tests in which plugging performance in a blade-cut slot was compared with performance of a slot that was created using an electric arc on a flat carbon steel coupon. Creation of the slot using an electric arc produced a smooth slot wall in contrast to the irregular or striated surface of a blade-cut slot. The test results demonstrated that a smooth wall markedly reduces slot plugging tendencies. However, to date no practical techniques have been devised whereby an electric arc can cut a slot in round pipe.

The present invention involves the application of a smooth durable coating to the slot wall such that the coating covers and thereby reduces the relief of the surface irregularities or striations. The net result of this coating is that the ultra-fine solid particles that would plug and back up when exposed to the striations present in a blade-cut slot now move smoothly through the slot while sand control is maintained at the slot entry. The coating reduces the plugging of the slots and reduces the pressure drop through the slots.

One could choose to enlarge the slot width of a blade-cut slot so as to reduce the impact of fines adhering to the slot wall. However, this approach will have the undesirable effect of allowing larger solid particles through the slots and into the equipment. The larger slots may also inhibit the desired bridging effect at the slot entry.

In a first aspect, the present invention provides a method of providing a slotted liner for petroleum fluid production including providing a tubular member having an exterior surface and an interior surface, the tubular member having a plurality of slots extending between the exterior surface and the interior surface, the plurality of slots having uncoated slot surfaces, and coating at least a portion of the uncoated slot surfaces with a surface coating of a surface coating thickness to form coated slot surfaces.

Preferably, the surface roughness of the coated slot surfaces is between about 1 percent and about 50% of the roughness of the uncoated slot surfaces. More preferably, the surface roughness of the coated slot surfaces is about 10 percent of the roughness of the uncoated slot surfaces. Preferably, the surface coating substantially covers the uncoated slot surfaces. Preferably, a bond is formed between the surface coating and the uncoated slot surfaces. Preferably, the bond is a molecular bond.

Preferably, the surface coating is selected from the group of a ceramic, polytetrafluoroethylene such as Teflon™, a passivation coating such as Sulfinert™ and a phenolic resin. Preferably, the surface coating thickness is between about 1/1000 inch (0.025 mm) and about 2/1000 inch (0.050 mm). Preferably, the surface coating thickness is substantially 1/1000 inch (0.025 mm).

Preferably, the method further includes selecting a net slot width, and selecting a surface coating thickness, wherein the slots are cut having a cut slot width substantially equal to the sum of the net slot width plus two times the surface coating thickness. Preferably, the net slot width is substantially 8/1000 inch (0.20 mm). Preferably, the cut slot width is substantially 10/1000 inch (0.25 mm) and the surface coating thickness is substantially 1/1000 inch (0.025 mm).

Preferably, the method further includes determining the surface roughness of the uncoated slot surfaces, wherein the surface coating thickness is substantially greater than or equal to the surface roughness of the uncoated slot surfaces.

Preferably, the method further includes determining a depth of surface irregularities or striations of the uncoated slot surfaces, wherein the surface coating thickness is substantially greater than or equal to the depth of the surface irregularities or striations.

In a further aspect, the present invention provides a slotted liner for petroleum fluid production including a tubular member having an exterior surface and an interior surface, and a plurality of slots extending between the exterior surface and the interior surface, the plurality of slots having internal slot surfaces, and a surface coating of a surface coating thickness applied to at least a portion of the uncoated slot surfaces to form coated slot surfaces.

Preferably, the surface coating substantially covers the uncoated slot surfaces. Preferably, a bond is formed between the surface coating and the slot surfaces. Preferably, the bond is a molecular bond. Preferably the surface coating is selected from the group of a ceramic, polytetrafluoroethylene such as Teflon™, a passivation coating such as Sulfinert™ and a phenolic resin.

Preferably, the surface coating thickness is between about 1/1000 inch (0.025 mm) and about 2/1000 inch (0.050 mm). Preferably, the surface coating thickness is substantially 1/1000 inch (0.025 mm).

Preferably, the slots are straight cut or keystone cut.

In a further aspect the present invention provides the use of a surface coating for smoothening uncoated slot surfaces formed in a plurality of slots extending between an exterior surface and an interior surface of a tubular slotted liner for petroleum fluid production.

Preferably, the surface coating is selected from the group of a ceramic, polytetrafluoroethylene such as Teflon™, a passivation coating such as Sulfinert™ and a phenolic resin.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a slotted liner of the present invention having longitudinal slots;

FIG. 2 is a slotted liner of the present invention having transverse slots;

FIG. 3a is a detail of a straight cut slot of the present invention along section 3-3 of FIG. 1 or 2; and

FIG. 3b is a detail of a keystone cut slot of the present invention along section 3-3 of FIG. 1 or 2.

### DETAILED DESCRIPTION

The present invention teaches that coating a slot whose walls possess surface irregularities or striations, such as those which are evident in a blade-cut slot, with a suitable material so as to cover the striations that had occurred during blade cutting, will materially inhibit the plugging tendency of clays or other fines. Any of several coatings will be effective in this respect, and the present invention does not limit the concept by specifying a particular coating.

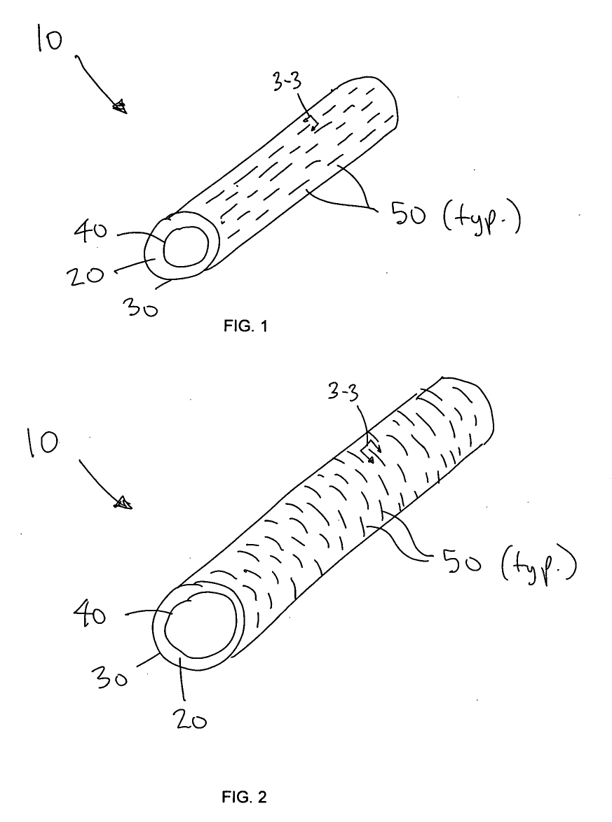

Referring to FIGS. 1 and 2, a typical slotted liner 10 includes a tubular member 20 having an exterior surface 30 and an interior surface 40 and a plurality of slots 50 extending therebetween. The slots 50 are typically longitudinal (FIG. 1) or transverse (FIG. 2) or a combination thereof (not shown).

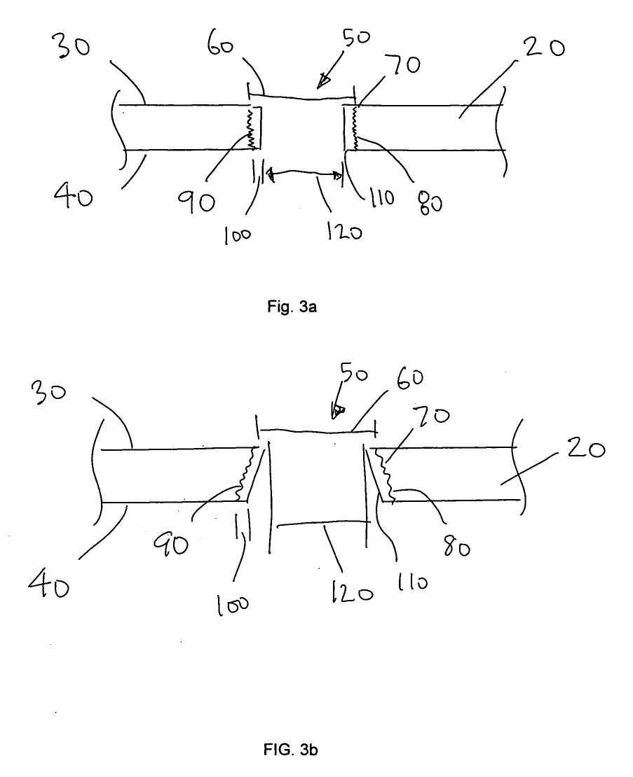

Referring to FIGS. 3a and 3b a slot 50 extends between the exterior surface 30 and the interior surface 40 of the tubular member 20. The slot 50 is cut to a cut slot width 60 between providing uncoated slot surfaces 70. As shown in FIG. 3a the slot 50 is straight cut, with the cut slot width 60 generally uniform between the exterior surface 30 and the interior surface 40. As shown in FIG. 3b the slot 50 is keystone cut, with the cut slot width 60 generally increasing between the exterior surface 40 and the interior surface 40.

The uncoated slot surfaces 70 may have a surface roughness 80 and surface irregularities or striations 90. The degree and magnitude of the surface roughness 80 and/or surface irregularities or striations 90 may depend on the manufacturing process used for creating the slots, with mechanical blades creating a rougher surface than laser or arc cut slots. A surface coating 100 is applied to the uncoated slot surface 70 to provide a coated slot surface 110 with reduced surface roughness 80. The coating may at least partially or even substantially or fully cover or smooth the surface irregularities or striations 90.

The surface coating 100 has a surface thickness 110, and the cut slot width 60 may be increased by the surface thickness 110 (on both surfaces) to provide a selected net slot width 120 which accommodates the reduction in slot width due to the coating.

As shown, the surface thickness 110 is shown exaggerated. The surface thickness 110 may be as small as a microscopic coating along a portion of the uncoated slot surface 70 to smooth the surface irregularities or striations 90. The surface thickness 110 may be substantially equal to the depth of the irregularities or striations 90 to form a substantially smooth coated slot surface 110.

A wide variety of smooth and durable coatings may be used. Without setting boundaries on the choice of coating, a number of coatings were tested and found to be effective. These included ceramics, Teflon™, Sulfinert™ and phenolic resin. Specifically, slots coated with these materials were tested at high oil, water and gas rates in a non-thermal environment for a period of time. Examination of the coatings using SEM (Scanning Electron Microscopy) following these tests confirmed that in all cases the integrity of the coating, and of the coating-metal bond, had not been compromised. The general durability of these coatings on a much longer term basis has been demonstrated in their many applications, including applications within the petroleum industry. However, any coating known to one skilled in the art may be suitable for the present invention.

A coating such as Sulfinert™ is of particular value in the case of sour service.

A coating may be applied in a wide range of thicknesses. However, preferably the coating is about 1/1000 inch to 2/1000 inch. More preferably, the coating is about 1/1000 inch. Most preferably, the coating is a molecular level coating.

In the case of thicker coatings, for example the 1/1000 inch (0.025 mm) coating, the slot width may be adjusted to compensate so that the net slot width is maintained. As an example, if a desired slot width of 8/1000 inch (0.20 mm) is desired, a 10/1000 inch (0.25 mm) slot could be cut and then coated with a 1/1000 inch (0.025 mm) coating (two surfaces) to net an 8/1000 inch (0.20 mm) coated slot.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method of providing a slotted liner for petroleum fluid production comprising:
a. providing a tubular member having an exterior surface and an interior surface, the tubular member having a plurality of slots extending between the exterior surface and the interior surface, the plurality of slots having uncoated slot surfaces; and
b. coating at least a portion of the uncoated slot surfaces with a surface coating of a surface coating thickness to form coated slot surfaces.

2. The method of claim 1, wherein the surface roughness of the coated slot surfaces is between about 1 percent and about 50% of the roughness of the uncoated slot surfaces.

3. The method of claim 2, wherein the surface roughness of the coated slot surfaces is about 10 percent of the roughness of the uncoated slot surfaces.

4. The method of claim 1, wherein the surface coating substantially covers the uncoated slot surfaces.

5. The method of claim 1, wherein a bond is formed between the surface coating and the uncoated slot surfaces.

6. The method of claim 1, wherein the surface coating is selected from the group of a ceramic, polytetrafluoroethylene such as Teflon™, a passivation coating such as Sulfinert™ and a phenolic resin.

7. The method of claim 1, wherein the surface coating thickness is between about 1/1000 inch (0.025 mm) and about 2/1000 inch (0.050 mm).

8. The method of claim 7, wherein the surface coating thickness is substantially 1/1000 inch (0.025 mm).

9. The method of claim 1, further comprising:
a. selecting a net slot width;
b. selecting a surface coating thickness,
wherein the slots are cut having a cut slot width substantially equal to the sum of the net slot width plus two times the surface coating thickness.

10. The method of claim 9, wherein the net slot width is substantially 8/1000 inch (0.20 mm).

11. The method of claim 10, wherein the cut slot width is substantially 10/1000 inch (0.25 mm) and the surface coating thickness is substantially 1/1000 inch (0.025 mm).

12. The method of claim 5, wherein the bond is a molecular bond.

13. The method of claim 1, further comprising determining the surface roughness of the uncoated slot surfaces, wherein the surface coating thickness is substantially greater than or equal to the surface roughness of the uncoated slot surfaces.

14. The method of claim 1, further comprising determining a depth of surface irregularities or striations of the uncoated slot surfaces, wherein the surface coating thickness is substantially greater than or equal to the depth of the surface irregularities or striations.

15. A slotted liner for petroleum fluid production comprising:
a. a tubular member having an exterior surface and an interior surface, and a plurality of slots extending between the exterior surface and the interior surface, the plurality of slots having internal slot surfaces; and
b. a surface coating of a surface coating thickness applied to at least a portion of the uncoated slot surfaces to form coated slot surfaces.

16. The slotted liner of claim 15, wherein the surface coating substantially covers the uncoated slot surfaces.

17. The slotted liner of claim 15, wherein a bond is formed between the surface coating and the slot surfaces.

18. The slotted liner of claim 15, wherein the surface coating is selected from the group of a ceramic, polytetrafluoroethylene such as Teflon™, a passivation coating such as Sulfinert™ and a phenolic resin.

19. The slotted liner of claim 15, wherein the surface coating thickness is between about 1/1000 inch (0.025 mm) and about 2/1000 inch (0.050 mm).

20. The slotted liner of claim 19, wherein the surface coating thickness is substantially 1/1000 inch (0.025 mm).

21. The slotted liner of claim 17, wherein the bond is a molecular bond.

22. The slotted liner of claim 15, wherein the slots are straight cut.

23. The slotted liner of claim 15, wherein the slots are keystone cut.

24. The use of a surface coating for smoothening uncoated slot surfaces formed in a plurality of slots extending between an exterior surface and an interior surface of a tubular slotted liner for petroleum fluid production.

25. The use of claim 24, wherein the surface coating is selected from the group of a ceramic, polytetrafluoroethylene such as Teflon™, a passivation coating such as Sulfinert™ and a phenolic resin.
